(19) United States
(12) Patent Application Publication
(10) Pub. No.: US 2020/0311587 A1
(43) Pub. Date: Oct. 1, 2020

(54) METHOD FOR EXTRACTING FEATURES, STORAGE MEDIUM, AND APPARATUS FOR EXTRACTING FEATURES

(71) Applicant: FUJITSU LIMITED, Kawasaki-shi (JP)

(72) Inventors: TOMOYUKI TSUNODA, Kawasaki (JP); YUHEI UMEDA, Kawasaki (JP)

(73) Assignee: FUJITSU LIMITED, Kawasaki-shi (JP)

(21) Appl. No.: 16/827,877

(22) Filed: Mar. 24, 2020

(30) Foreign Application Priority Data
Mar. 28, 2019 (JP) 2019-064972

(51) Int. Cl. G06N 7/00; G06K 19/06

(52) U.S. Cl. CPC G06N 7/005; G06K 19/06028

(57) ABSTRACT

A method for extracting features, the method being implemented by a computer, the method includes generating attractors from time series data having a cyclic characteristic; generating a persistence diagram by performing persistent homology conversion for the attractors; changing a degree of influence with respect to individual items of data in the persistence diagram in accordance with a time of existence or an appearance time of a hole generated by performing the persistent homology conversion; and extracting features of the time series data from the changed persistence diagram in which the degree of influence has been changed.

### CROSS-REFERENCE TO RELATED APPLICATION

This application is based upon and claims the benefit of priority of the prior Japanese Patent Application No. 2019-64972, filed on Mar. 28, 2019, the entire contents of which are incorporated herein by reference.

### FIELD

The embodiments discussed herein are related to a method for extracting features, a storage medium, and an apparatus for extracting features.

### BACKGROUND

An analysis method using topological data analysis (TDA) is known as a technology for detecting changes corresponding to anomaly in data by analyzing time series data such as brain waves data or acceleration data. For example, time series data is input and sectioned into subsets, the subsets of time series data are in turn converted into figures referred to as quasi-attractors that are a finite number of attractors. When a feature of a figure is extracted by performing persistent homology conversion (PH conversion), a persistence diagram on which the generation (appearance) and the disappearance of a hole serving as a feature are plotted is generated, bar code data is generated from the persistence diagram, and consequently, Betti numbers are calculated.

Betti sequences are created from the Betti numbers generated in this manner, and by using the Betti sequences as a feature vector, machine learning is performed and a learning model is created. By using the trained learning model, anomaly in time series data is detected. As the related art, for example, International Publication Pamphlet No. WO 2006/137142, Japanese Laid-open Patent Publication Nos. 11-142425, 2018-92349, and 2017-97643 are disclosed.

### SUMMARY

According to an aspect of the embodiments, A method for extracting features, the method being implemented by a computer, the method includes generating attractors from time series data having a cyclic characteristic; generating a persistence diagram by performing persistent homology conversion for the attractors; changing a degree of influence with respect to individual items of data in the persistence diagram in accordance with a time of existence or an appearance time of a hole generated by performing the persistent homology conversion; and extracting features of the time series data from the changed persistence diagram in which the degree of influence has been changed.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 illustrates a feature extraction apparatus according to an embodiment 1;

FIG. 2 is a diagram for explaining an overall view in the case of applying the feature extraction apparatus to learning processing and inference processing;

FIG. 3 is a functional block diagram illustrating a functional configuration of the feature extraction apparatus according to the embodiment 1;

FIG. 4 illustrates an example of time series data;

FIG. 5 illustrates an example of time series data;

FIGS. 6A to 6D illustrate persistent homology;

FIG. 7 illustrates correspondence between bar code data and generated continuous data;

FIG. 8 illustrates a persistence diagram;

FIG. 9 is a diagram for explaining general denoising;

FIG. 10 is a diagram for explaining a problem of the general denoising;

FIG. 11 is a diagram for explaining a reason that information in which the time of existence is relatively short is not necessarily noise;

FIG. 12 is a diagram for explaining denoising for data in which amplitude is relatively small;

FIG. 13 is an illustration for explaining a reason 1 that a component that appears early serves as a noise;

FIG. 14 is an illustration for explaining a reason 2 that a component that appears early serves as a noise;

FIG. 15 is a diagram for explaining weight setting of the embodiment 1;

FIG. 16 is a table for explaining an example of weight setting;

FIG. 17 is a diagram illustrating a change in a Betti sequence between before and after weight setting;

FIG. 18 is a flowchart illustrating a processing flow;

FIG. 19 is an illustration depicting an example of learning in the application to dassification of person's motion;

FIG. 20 is an illustration depicting an example of inference in the application to dassification of person's motion;

FIG. 21 is an illustration for explaining a method according to an embodiment 2;

FIG. 22 is an illustration for explaining an example in which a method according to the embodiment 2 is applied to anomaly detection;

FIG. 23 is an illustration for explaining an example in which a method according to the embodiment 2 is applied to anomaly detection; and

FIG. 24 illustrates an example of a hardware configuration.

### DESCRIPTION OF EMBODIMENTS

Incidentally, when a Betti sequence is generated by using entire data of the persistence diagram, information about noise in which the timing of generation and the timing of disappearance are close to each other, that is, noise in which the time of existence is short is included. It is thus considered to improve accuracy in extracting features in time series data by removing information in which the time of existence is relatively short from the persistence diagram and accordingly generating a Betti sequence.

However, if information in which the time of existence is relatively short is completely removed, when multiple items of time series data fulfil criteria for removal, it is impossible to distinguish the multiple items of time series data from each other. In the case of time series data of relatively small amplitude, a noise component in some cases appears in a range in which the time of existence is not short and this may adversely affect feature extraction. In consideration of the above circumstances, it is desired to extract features with good accuracy.

Hereinafter, embodiments of a method for extracting features, a program for extracting features, and an apparatus for extracting features disclosed in the present application are described in detail with reference to the drawings. The embodiments do not limit the present disclosure. The embodiments may be combined with each other as appropriate when there is no contradiction.

### Embodiment 1

[Description of Apparatus for Extracting Features]

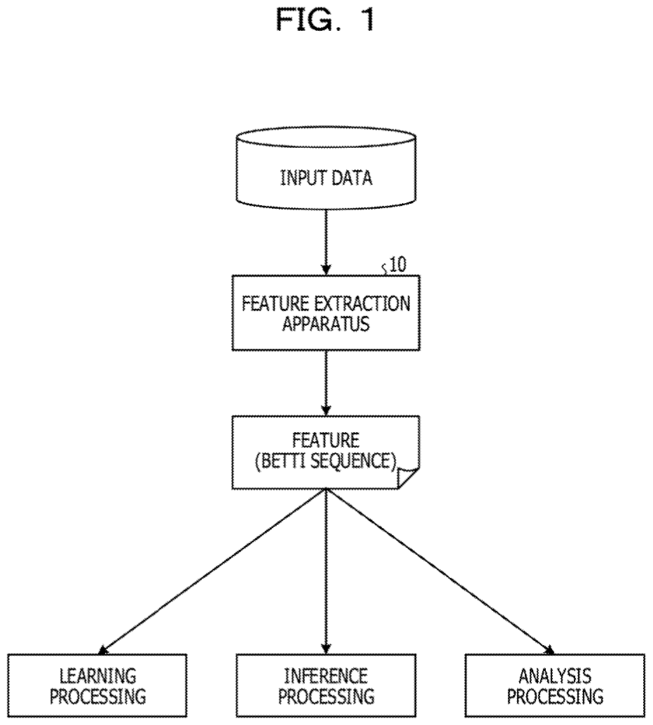

FIG. 1 illustrates a feature extraction apparatus 10 according to an embodiment 1. As illustrated in FIG. 1, the feature extraction apparatus 10 generates multiple quasi-attractors from input data as time series data and specifies the appearance and disappearance of a hole by performing persistent homology conversion (PH conversion) for each of the quasi-attractors. The feature extraction apparatus 10 then generates a persistence diagram (hereinafter simply referred to as a “a diagram” in some cases) in which the appearance time (Birth) and the disappearance time (Death) of each hole are plotted and extracts the time of existence of each hole in accordance with the distance from a diagonal line indicating that the time of existence is zero.

The feature extraction apparatus 10 changes importance by setting weight for the time of existence and the appearance time and then generates bar code data and a Betti sequence. The Betti sequence generated in this manner is used as a feature of input data for, for example, learning processing of learning a feature of each data item, inference processing performed by using a learned model, and analysis processing performed for, for example, detecting anomaly by using features.

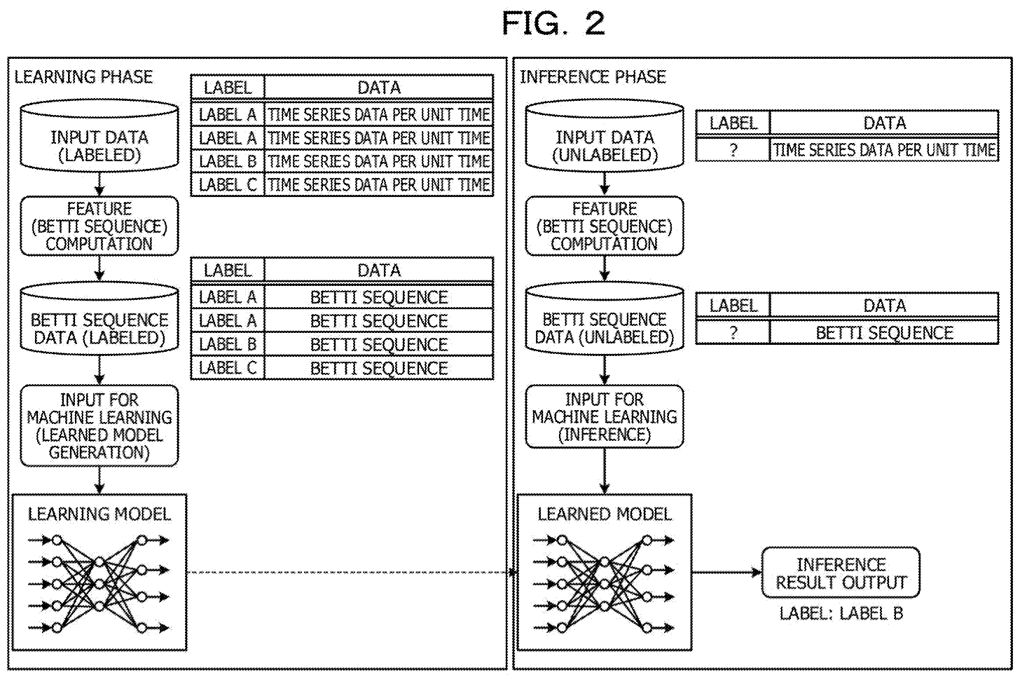

Here, an example in which the feature extraction apparatus 10 is applied to learning processing and inference processing. FIG. 2 is a diagram for explaining an overall view in the case of applying the feature extraction apparatus 10 to learning processing and inference processing.

As illustrated in FIG. 2, in a learning phase, the feature extraction apparatus 10 performs attractor generation, PH conversion, diagram generation, weight setting, and Betti-sequence generation for labeled input data such as “time series data per unit time” assigned “label A”. The feature extraction apparatus 10 consequently generates a labeled Betti sequence (a feature) corresponding to particular labeled input data. Subsequently, the feature extraction apparatus 10 inputs a labeled Betti sequence for machine learning and learns a model for predicting a label in accordance with a Betti sequence.

In an inference phase, the feature extraction apparatus 10 performs attractor generation, PH conversion, diagram generation, weight setting, and Betti-sequence generation for unlabeled input data such as “time series data per unit time” assigned “label A” that is measurement data. The feature extraction apparatus 10 generates a Betti sequence (a feature) corresponding to unlabeled input data, inputs the Betti sequence to the learned model, and obtains an output result of the learned model. The feature extraction apparatus 10 then identifies a label of the input data in accordance with the output result of the learned model.

While the example in which the feature extraction apparatus 10 performs learning processing and inference processing is described here, this is a mere example and feature extraction processing, learning processing, and inference processing may be performed separately by different apparatuses.

[Functional Configuration]

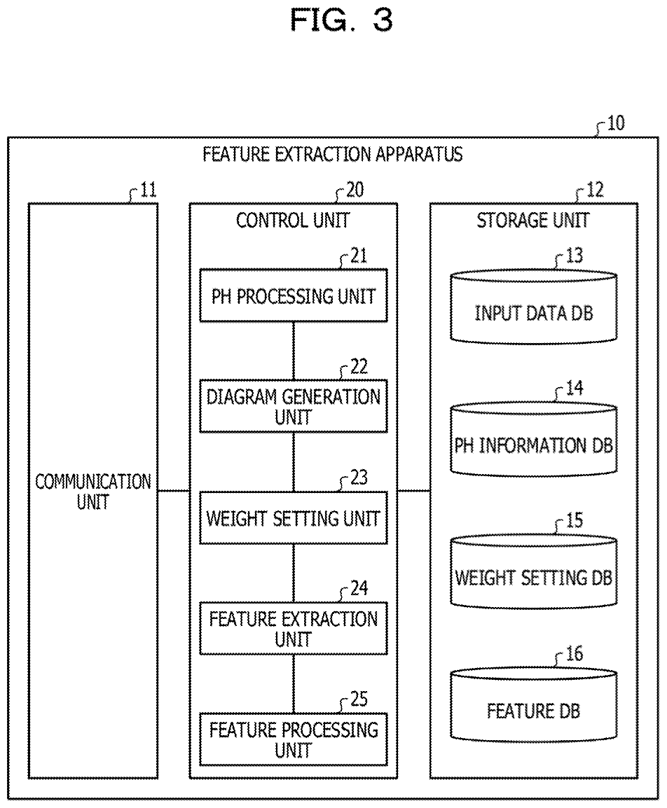

FIG. 3 is a functional block diagram illustrating a functional configuration of the feature extraction apparatus 10 according to the embodiment 1. As illustrated in FIG. 3, the feature extraction apparatus 10 includes a communication unit 11, a storage unit 12, and a control unit 20.

The communication unit 11 is a processing unit that controls communications with another device and implemented as, for example, a communication interface. For example, the communication unit 11 receives time series data, such as brain wave data measured by an electroencephalograph or acceleration data obtained by a wearable sensor or the like, as input data from the corresponding measuring device.

The storage unit 12 is an example of a storage device that stores, for example, data and a program to be run by the control unit 20 and implemented as, for example, a memory or a hard disk. The storage unit 12 stores an input data database (DB) 13, a PH information DB 14, a weight setting DB 15, and a feature DB 16.

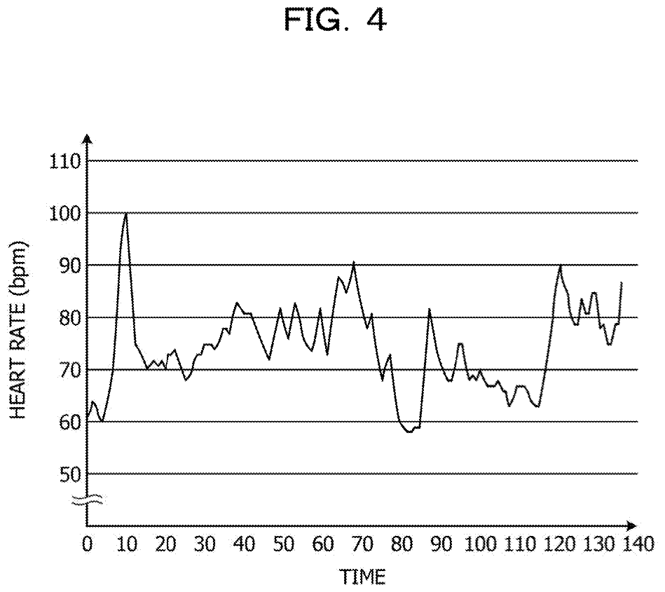

The input data DB 13 is a database that stores time series data targeted for feature extraction. This embodiment is described by using, as input data, time series data having a cyclic characteristic such as time series data indicating changes in heart rate. FIG. 4 illustrates an example of time series data. FIG. 4 is a graph representing time series data indicating changes in heart rate, in which the vertical axis indicates heart rate (beats per minute) and the horizontal axis indicates time.

While the time series data of heart rate is used as an instance of continuous data in this example, time series data is not limited to this kind of data. The time series data may be, for example, biometric data except for heart rate (time series data indicating brain waves, pulse, body temperature, or the like) or wearable sensor data (time series data obtained by a gyro sensor, an acceleration sensor, a geomagnetic sensor, or the like). The time series data may also be, for example, financial data (time series data indicating interest rates, commodity prices, balance of international payments, stock prices, or the like), natural environment data (time series data indicating temperature, humidity, carbon dioxide levels, or the like), or social data (labor statistics data, demographic statistics data, or the like).

The PH information DB 14 is a database that stores information generated by performing, for example, attractor generation and PH conversion. For example, the PH information DB 14 stores, for example, coordinates of each point of a set of points of a quasi-attractor, the appearance time and the disappearance time of each hole generated by PH conversion, and the time of existence of each hole.

The weight setting DB 15 is a database that stores information about weight given for the persistence diagram. For example, the weight setting DB 15 stores set weights in association with, for example, the appearance time (an existence value) at which a hole is generated or the time of existence that is a difference between the appearance time and the disappearance time of the hole.

The feature DB 16 is a database that stores features generated by the control unit 20. For example, the feature DB 16 stores information about bar code data in which weights are set and information about a Betti sequence used as features in learning processing and inference processing.

The control unit 20 is a processing unit that controls entire processing of the feature extraction apparatus 10 and implemented as, for example, a processor. The control unit 20 includes a PH processing unit 21, a diagram generation unit 22, a weight setting unit 23, a feature extraction unit 24, and a feature processing unit 25. The PH processing unit 21, the diagram generation unit 22, the weight setting unit 23, the feature extraction unit 24, and the feature processing unit 25 are an example of electronic circuits included in a processor or the like or processes that are executed by a processor or the like.

The PH processing unit 21 is a processing unit that performs attractor generation and PH conversion for input data. Specifically, the PH processing unit 21 reads input data stored in the input data DB 13 and generates quasi-attractors from the input data. The PH processing unit 21 extracts the appearance time and the disappearance time of each hole by performing persistent homology conversion for the quasi-attractors and stores the appearance time and the disappearance time of each hole in the PH information DB 14.

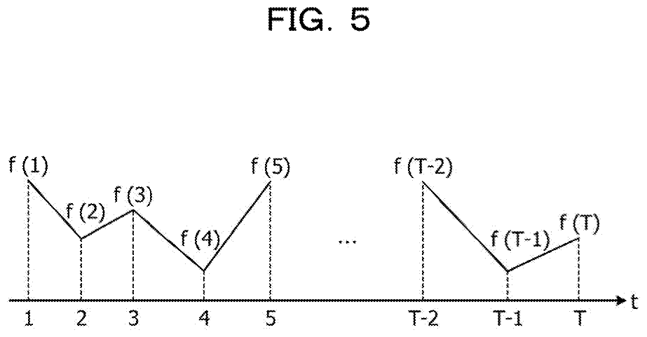

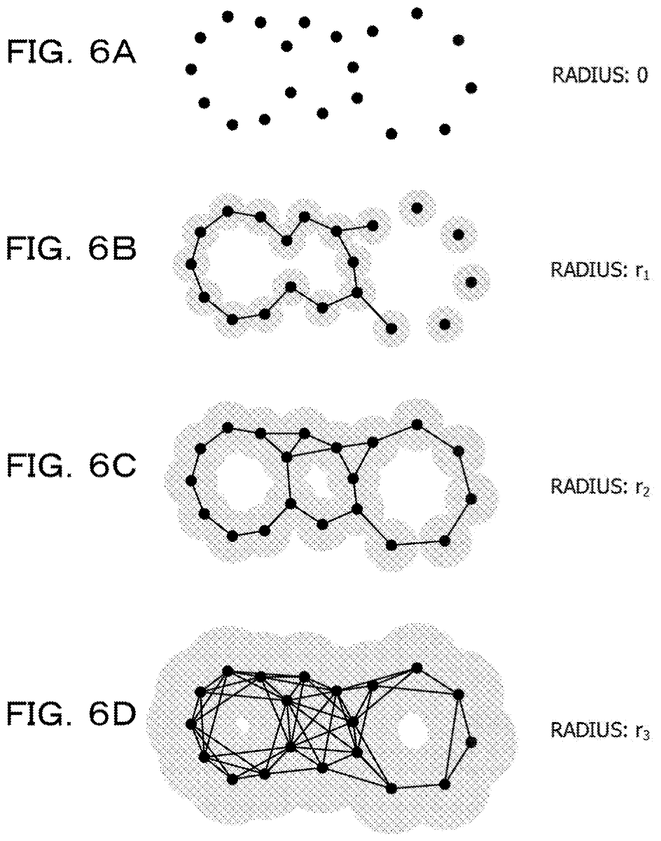

With reference to FIGS. 5 and 6A to 6D, Betti-sequence generation performed by employing a method almost identical to the method in Japanese Laid-open Patent Publication No. 2017-97643 is simply explained. While hole dimensions including zero-dimension, one-dimension, and two-dimension are described here, zero-dimensional and one-dimensional holes are targeted in the embodiment 1. In Japanese Laid-open Patent Publication No. 2017-97643, a radius range [rₘᵢₙ, rₘₐₓ] used for computing Betti numbers divided by m−1, a Betti number B(rᵢ) is computed with respect to each radius r (i=1, . . . , m), and a Betti sequence in which the Betti numbers [B(r₁), B(r₂), B(r₃), . . . , B(rₘ)] are ordered is accordingly generated.

FIG. 5 illustrates an example of time series data. FIGS. 6A to 6D illustrate persistent homology. The generation of quasi-attractor is described with reference to FIG. 5. For example, the case of continuous data represented by a function f(t) (t denotes a time) as illustrated in FIG. 5 is considered as an example. It is assumed that actual values f(1), f(2), f(3), . . . , f(T) are given. The quasi-attractor in the present embodiment is a set of points in an N-dimensional space in which values of N points obtained from continuous data successively at delay time τ (τ≥1) intervals are used as components. Here, N is an embedding dimension and usually N=3 or 4. For example, when N=3 and T=1, a quasi-attractor containing (T−2) points is generated as follows.

Quasi-attractor={(f(1),f(2),f(3)),(f(2),f(3),f(4)),(f(3),f(4),f(5)), . . . ,(f(T−2),f(T−1),f(T))}

Subsequently, the PH processing unit 21 generates a quasi-attractor, extracts appearance and disappearance of each hole by employing persistent homology conversion, and consequently performs conversion to a Betti sequence. The attractor generated here is referred to as a “quasi-attractor” because the attractor is a finite set of points.

“Homology” is a method of expressing features of an object by using the numbers of holes in m (m≥0) dimensions. The “hole” mentioned here is an element of a homology group. A zero-dimensional hole is a coupled component, a one-dimensional hole is a hole (a tunnel), and a two-dimensional hole is a void. The number of holes in each dimension is referred to as a Betti number. “Persistent homology” is a method for characterizing transitions of holes in m dimensions with respect to an object (a set of points (a point cloud) in this description) and enables defining features of the positions of points. In this method, each point in the object is gradually expanded to form a spherical shape, and during this process, the time at which a particular hole appears (the time is represented by the radius of the corresponding sphere at the time of appearance) and the time at which a particular hole disappears (the time is represented by the radius of the sphere at the time of disappearance) are specified.

The persistent homology is more specifically described with reference to FIGS. 6A to 6D. The rule is that, when two spheres abut each other, the centers of the two spheres are joined to each other by a line segment; when three spheres abut each other, the centers of the three spheres are joined to each other by a line segment. Here, only coupled components and holes are considered. In the case in FIG. 6A (radius r=0), only coupled components appear and no hole appears. In the case in FIG. 6B (radius r=r₁), a hole appears and the coupled components partially disappear. In the case in FIG. 6C (radius r=r₂), more holes appear and only one of the coupled components remains. In the case in FIG. 6D (radius r=r₃), the number of coupled components remains at one and one hole disappears.

In the computation process of persistent homology, the radius of appearance and the radius of disappearance of an element (a hole) of a homology group are computed. By using the radius of appearance and the radius of disappearance of a hole, bar code data is generated. An item of bar code data is generated for each dimension of a particular hole and a set of bar code data is generated by combining together multiple items of bar code data corresponding to respective dimensions of holes. Continuous data represents correspondence between a radius (a time) of a sphere in persistent homology and a Betti number.

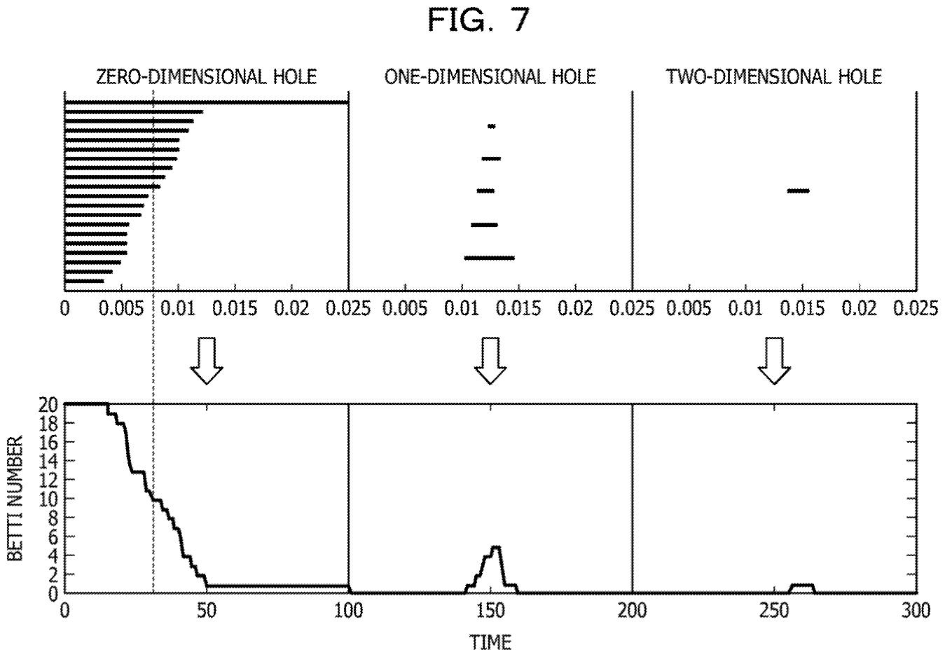

Here, generation of usual bar code data is simply explained. FIG. 7 illustrates correspondence between bar code data and generated continuous data. The upper graph in FIG. 7 is generated from bar code data, in which the horizontal axis represents the radius. The lower graph is generated from continuous data (also referred to as a Betti sequence), in which the vertical axis represents the Betti number and the horizontal axis represents time. Since the Betti number represents the number of holes as described above, for example, when the radius is a particular radius indicated by a dashed line in the upper graph, the number of holes that exist is ten, and thus, the Betti number indicated by the dashed line in the lower bottom is also ten. The Betti numbers are counted for each block. The lower graph is a graph of pseudo-time series data and values represented by the horizontal axis does not mean anything.

Referring back to FIG. 3, the diagram generation unit 22 is a processing unit that generates a persistence diagram by using a processing result of the PH processing unit 21. Specifically, the diagram generation unit 22 obtains from the PH information DB 14 the appearance time and the disappearance time of each hole obtained by performing PH conversion and accordingly generates a persistence diagram. The diagram generation unit 22 then generates bar code data from plotting results of the persistence diagram and stores the result in the PH information DB 14.

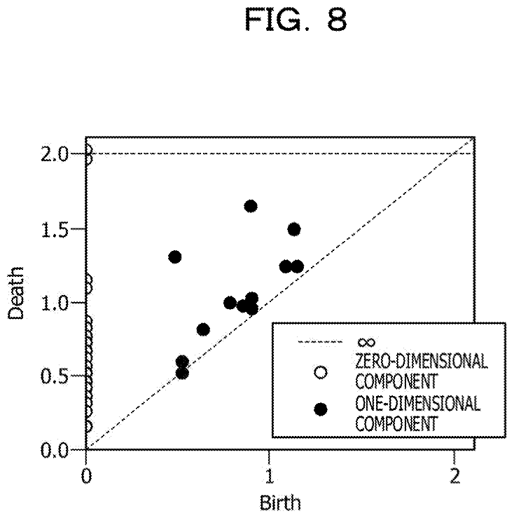

FIG. 8 illustrates a persistence diagram. As illustrated in FIG. 8, the diagram generation unit 22 generates a diagram in which the horizontal axis indicates the appearance time (Birth) and the vertical axis indicates the disappearance time (Death). The diagonal line in this diagram corresponds to holes that disappears immediately after their appearance, that is, holes of which the time of existence is almost zero. In this embodiment, zero-dimensional and one-dimensional holes generated by performing PH processing are plotted, in which zero-dimensional holes are indicated by white circles and one-dimensional holes are indicated by black circles.

Here, the persistence diagram is described. The persistence diagram is a diagram generated in accordance with the radius of appearance and the radius of disappearance that are obtained by performing computation of persistent homology.

When such a persistence diagram is applied to this embodiment, each point (in this embodiment referred to as data or hole data in some cases) in the persistence diagram indicates a hole extracted by performing persistent homology conversion; a feature of time series data is extracted by setting an appearance axis indicating a parameter of appearance of a hole at one axis and an disappearance axis indicating a parameter of disappearance of a hole at another axis. Specifically, in the persistence diagram, it is possible to view a time interval between generation and disappearance of a hole; the diagonal line at the center of the diagram indicates that the time interval between appearance and disappearance of a hole is zero, and when the time interval between appearance and disappearance of a hole is relatively short, a diagram is generated close to the diagonal line and a corresponding hole is regarded as a noise. For example, in the case of electrocardiograms, which are formed of a waveform of large amplitude, the time interval between appearance and disappearance of a hole is relatively large, and as a result, a corresponding diagram is generated at a position apart from the diagonal line. In the case of brain waves in which amplitude is smaller than the waveform of electrocardiogram, the time interval between appearance and disappearance of a hole is relatively large, and as a result, a corresponding diagram is generated at a position close to the diagonal line.

The weight setting unit 23 is a processing unit that sets weight in the persistence diagram generated by the diagram generation unit 22. Specifically, the weight setting unit 23 determines that data in which the time of existence is equal to or shorter than a threshold and data in which the time of generation (the appearance time) is earlier than a threshold are likely to be noises and decreases the importance by lightening corresponding weights.

(Problems of General Denoising)

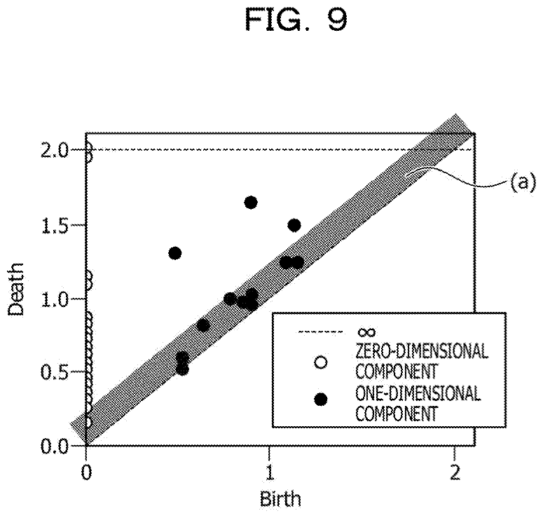

As general denoising, a method of removing any data in which the time of existence is relatively short is known. This is because, when there is an influence of noise components, such as micro-vibrations or high-frequency components, the noise components exist as isolated points in the attractor and the time of existence thereof is relatively short in many cases. FIG. 9 is a diagram for explaining general denoising. As illustrated in FIG. 9, in the general denoising, data plotted at a position within a fixed distance from the diagonal line in plotting results on the persistence diagram, that is, data corresponding to an area in which the time of existence is relatively short and that appears close to the diagonal line is deleted.

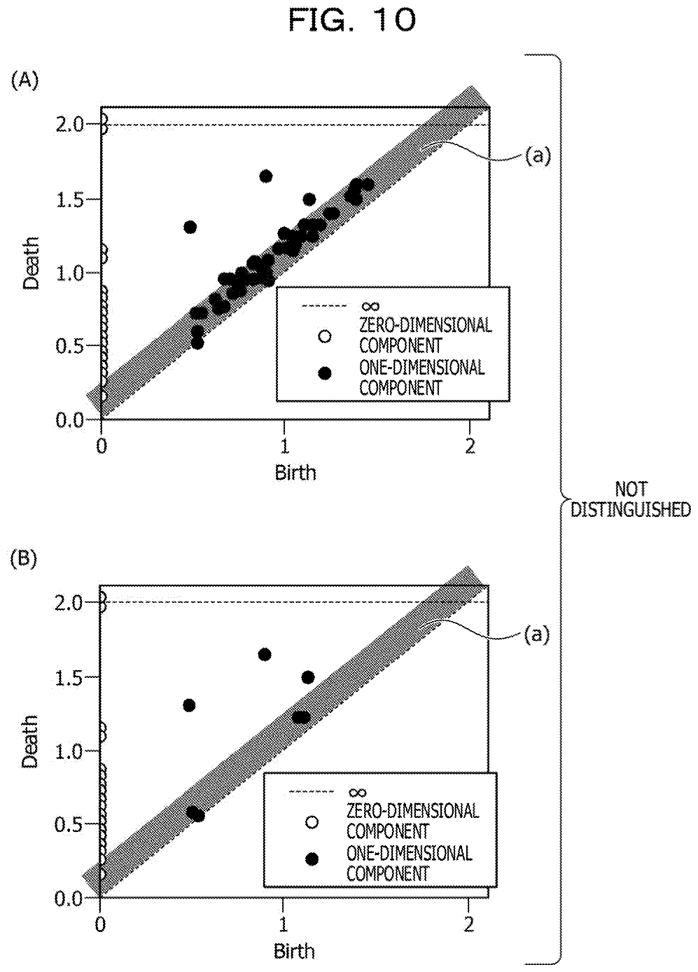

However, data in which the time of existence is relatively short is significant in some cases, disadvantages may occur when any data in which the time of existence is relatively short is assigned a zero degree of influence. FIG. is a diagram for explaining a problem of the general denoising. FIGS. 10(A) and 10(B) illustrate persistence diagrams generated from different sets of time series data. Concerning these persistence diagrams, different features are extracted from different sets of data when all plotting results of the respective persistence diagrams are targeted; however, when data corresponding to an area in which the time of existence is relatively short is deleted, both the different sets of data are almost the same and it is difficult to distinguish the different sets of data from each other.

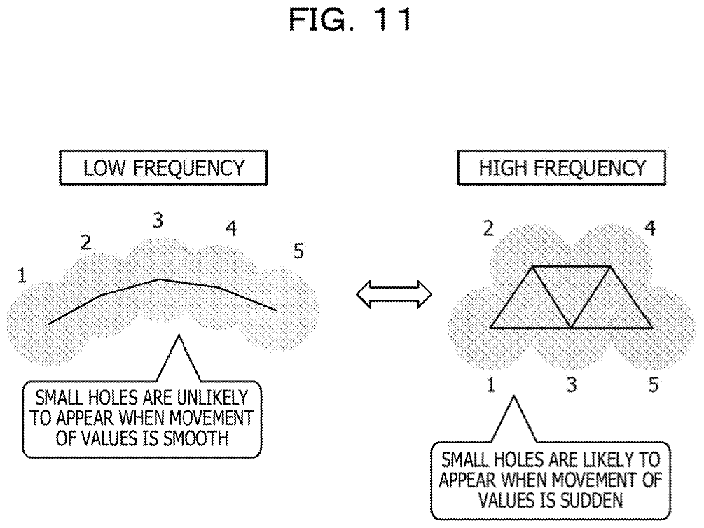

This is because, when many high-frequency components exist in input data, data in which the time of existence is relatively short increases. FIG. 11 is a diagram for explaining a reason that information in which the time of existence is relatively short is not necessarily noise. As illustrated in FIG. 11, when many low-frequency components exist, the movement of values is smooth and small holes that disappear immediately and that thus exist close to the diagonal line are unlikely to appear. By contrast, when many high-frequency components exist, the movement of values is sudden and small holes that disappear immediately and that thus exist close to the diagonal line are likely to appear. As a result, any data in which the time of existence is relatively short and that thus appears close to the diagonal line is deleted from input data containing many high-frequency components by employing the general method, high-frequency components that are part of features of the input data are deleted and the accuracy in extracting features from the input data is deteriorated.

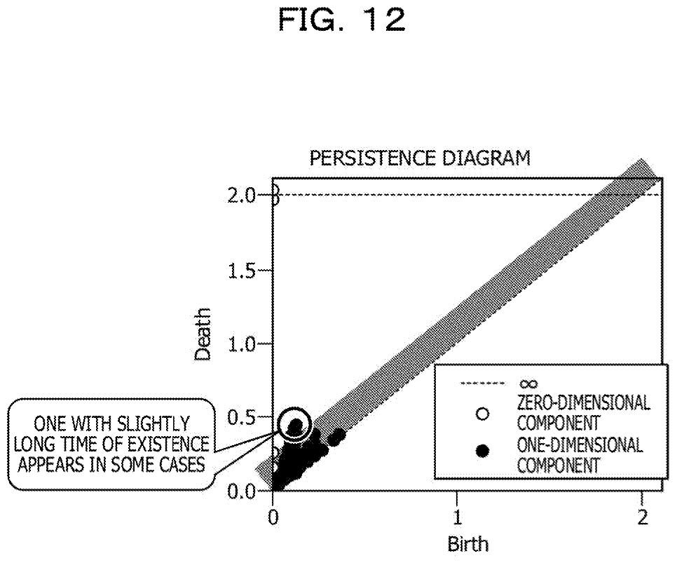

Since data in which amplitude is relatively small is easy to be influenced by noise, it is difficult to remove noise by employing the general denoising described above. FIG. 12 is a diagram for explaining denoising for data in which amplitude is relatively small. As illustrated in FIG. 12, the appearance time of data in which amplitude is relatively small is early and the time of existence of such data is relatively short, such data is usually removed by performing general denoising; however, such data is not targeted for denoising when the time of existence slightly extended due to the influence of noise.

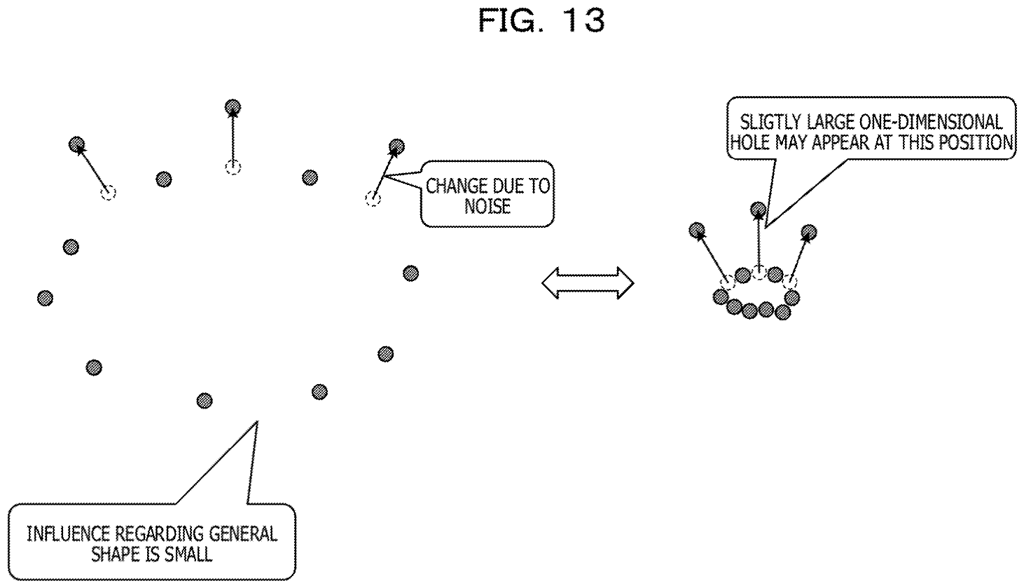

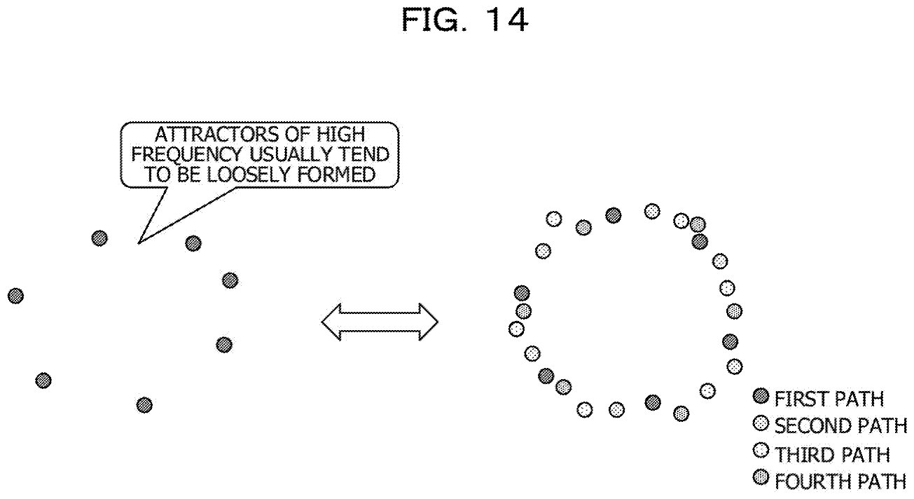

Here, a reason that a component that appears early serves as a noise is described. FIG. 13 is a diagram for explaining a reason 1 that a component that appears early serves as a noise. FIG. 14 is a diagram for explaining a reason 2 that a component that appears early serves as a noise. As illustrated in FIG. 13, although changes of noise in some cases affect the appearance time and the time of existence of a hole, the influence regarding the general shape is small and the effect regarding details of the shape is large. This means that, among the same noise components, a hole that corresponds to data in which amplitude is relatively small and that appears early is easily affected. As illustrated in FIG. 14, although attractors of high frequency usually tend to be loosely formed, when only components of a particular frequency are dominant, points contiguously appear on a single path and thus are close to each other, and thus, the appearance time of a hole is early.

(Example of Weight Setting)

In consideration of circumstances described above, the weight setting unit 23 performs weighting for the persistence diagram to suppress influences of data in which the time of existence is relatively short and also to suppress influences of portions in which the appearance time is early.

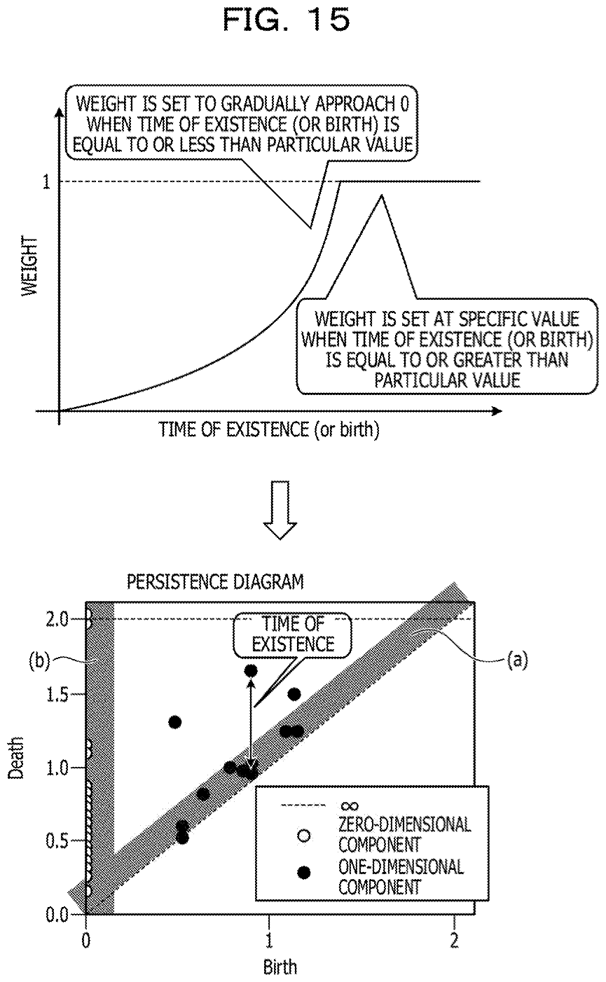

FIG. 15 is a diagram for explaining weight setting of the embodiment 1. As Illustrated in FIG. 15, when the time of existence or the appearance time is equal to or less than a particular value, the weight setting unit 23 sets weight to gradually approach 0; when the time of existence or the appearance time is equal to or greater than the particular value, the weight setting unit 23 sets weight at a specific value. With this configuration, the weight setting unit 23 changes weight between an area (a) that is a range extending up to a particular distance from the diagonal line of the persistence diagram and an area (b) that is a range in which the appearance time is equal to or earlier than a predetermined value, and as a result, the degree of influence of data included these areas is decreased.

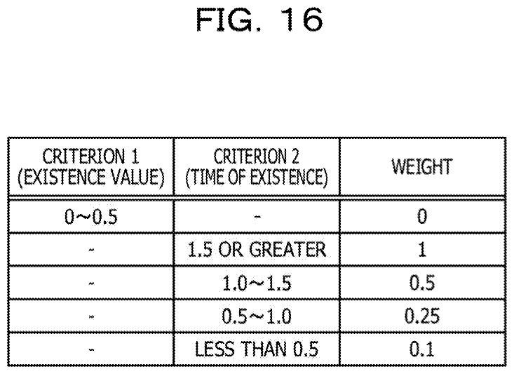

FIG. 16 is a table for explaining an example of weight setting. Considering the criteria in FIG. 15 described above, in the embodiment 1, information indicated in FIG. 16 is stored in the weight setting DB 15 or the like. As illustrated in FIG. 16, in the information stored in the weight setting DB 15, “criterion 1 (the existence value), criterion 2 (the time of existence), weight” are associated with each other. “Criterion 1” indicates a criterion of the appearance time, “criterion 2” indicates a criterion of the time of existence, and “weight” indicates a weight to be set.

In the example in FIG. 16, a weight “0” is set for data in a range of 0 to 0.5 of the appearance time (the existence value) regardless of the time of existence. Similarly, a weight “1” is set for data in which the time of existence is equal to or longer than 1.5 regardless of the existence value; a weight “0.5” is set for data in which the time of existence is equal to or longer than 1.0 and less than 1.5 regardless of the existence value; a weight “0.25” is set for data in which the time of existence is equal to or shorter than 0.5 and less than 1.0 regardless of the existence value; and a weight “0.1” is set for data in which the time of existence is shorter than 0.5 regardless of the existence value.

In accordance with the information about weight setting indicated in FIG. 16, the weight setting unit 23 sets weight for the persistence diagram generated by the diagram generation unit 22. The weight setting unit 23 then outputs the persistence diagram having been subjected to weighting to the feature extraction unit 24.

Referring back to FIG. 3, the feature extraction unit 24 is a processing unit that extracts features of time series data by using the persistence diagram having been subjected by the weight setting unit 23 to weighting. Specifically, the feature extraction unit 24 generates bar code data by using information about the persistence diagram stored in the PH information DB 14. The feature extraction unit 24 extracts Betti numbers from the bar code data and generates as a feature of time series data a Betti sequence in which the Betti numbers are ordered. Subsequently, the feature extraction unit 24 stores the Betti sequence in the feature DB 16.

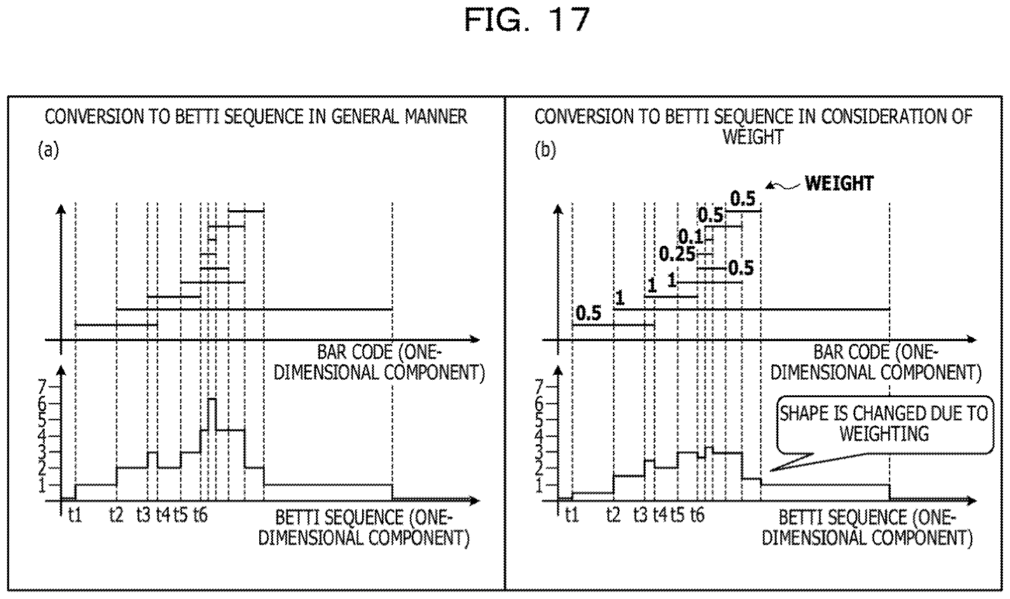

FIG. 17 is a diagram illustrating a change in a Beth sequence between before and after weight setting. FIG. 17 illustrates different items of bar code data based on a persistence diagram generated from particular time series data. FIG. 17(a) illustrates conversion to a Betti sequence in a general manner and FIG. 17(b) illustrates conversion to a Betti sequence in consideration of weight.

In the case of the general manner, as indicated in FIG. 17(a), a Betti sequence is generated as follows: a Betti number “1” for t1, a Betti number “2” for t2, a Betti number “3” for t3, a Betti number “2” for t4, a Betti number “3” for t5, and a Betti number “4” for t6.

On the other hand, as illustrated in FIG. 17(b), when bar code data is generated from the weighted persistence diagram by the weight setting unit 23, the feature extraction unit 24 is able to change Betti numbers in accordance with set weight. For example, the feature extraction unit 24 counts a bar code of a weight 0.5 as not 1 but 0.5.

For example, the feature extraction unit 24 computes a Betti number “0.5” for t1 because a hole assigned a weight “0.5” appears at t1, a Betti number “1.5” for t2 because a hole assigned a weight “1” additionally appears at t2, and a Betti number “2.5” for t3 because a hole assigned a weight “1” additionally appears at t3. The feature extraction unit 24 also computes a Betti number “2.0” for t4 because the hole of the weight “0.5” disappears at t4, a Betti number “3.0” for t5 because a hole of a weight “1” additionally appears, and a Betti number “2.75” for t6 because a hole of a weight “0.5” and a hole of a weight “0.25” appear and the hole of the weight “1” disappears. Since the feature extraction unit 24 computes a Betti sequence in such a manner, in consideration of weight, the feature extraction unit 24 is able to generate a Betti sequence in a form different from that of FIG. 17(a).

Referring back to FIG. 3, the feature processing unit 25 is a processing unit that performs various kinds of processing by using features generated by the feature extraction unit 24. For example, the feature processing unit 25 generates a learning model by performing machine learning with the use of features of multiple items of time series data stored in the feature DB 16 and labels associated with the features. The feature processing unit 25 also performs classification processing by inputting, to the learned model, features of multiple items of time series data stored in the feature DB 16.

[Processing Flow]

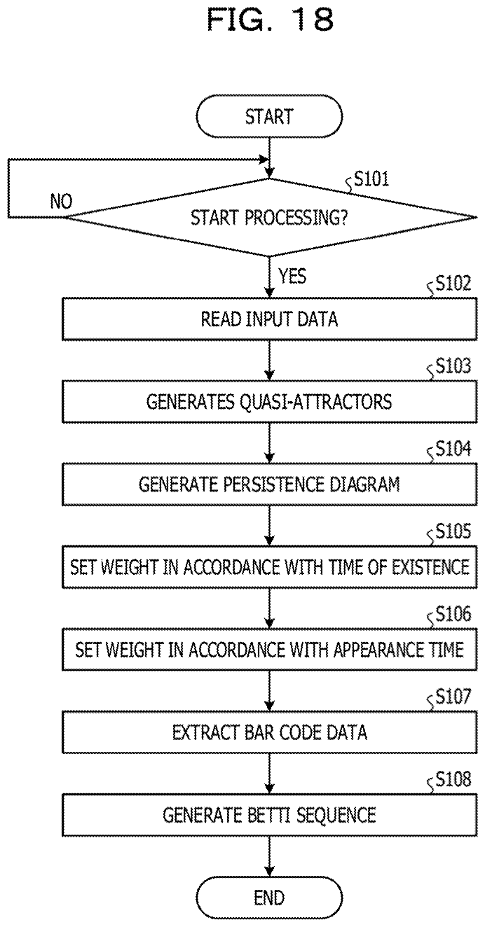

FIG. 18 is a flowchart illustrating a processing flow. As illustrated in FIG. 18, start of processing is ordered (Yes in S101), the PH processing unit 21 reads input data from the input data DB 13 (S102) and generates quasi-attractors (S103).

Subsequently, the diagram generation unit 22 generates a persistence diagram by performing TDA processing with the use of the quasi-attractors (S104). The weight setting unit 23 sets weight in accordance with the time of existence of each hole (S105) and also sets weight in accordance with the appearance time of each hole (S106). S105 and S106 are interchangeable in order.

Subsequently, the feature extraction unit 24 generates bar code data from the weighted persistence diagram (S107) and generates a Betti sequence based on the bar code data (S108).

[Effects]

As described above, the feature extraction apparatus 10 generates quasi-attractors from time series data; and when generating a persistence diagram from the generated quasi-attractors, weight for data in which the time of existence is equal to or shorter than a threshold and weight for data in which the appearance time is earlier than a threshold are lightened in the persistence diagram. The feature extraction apparatus 10 consequently extracts features time series data by using the weighted persistence diagram. As a result, when the feature extraction apparatus 10 extracts features by employing TDA, it is possible to extract features while influence of data in which the time of existence is relatively short is maintained, and thus, comparison between items of data having weak features may be performed. Furthermore, since the feature extraction apparatus 10 is able to suppress the influence of noise components in which the appearance time is early, it is possible to achieve feature extraction with improved accuracy.

### Application Example

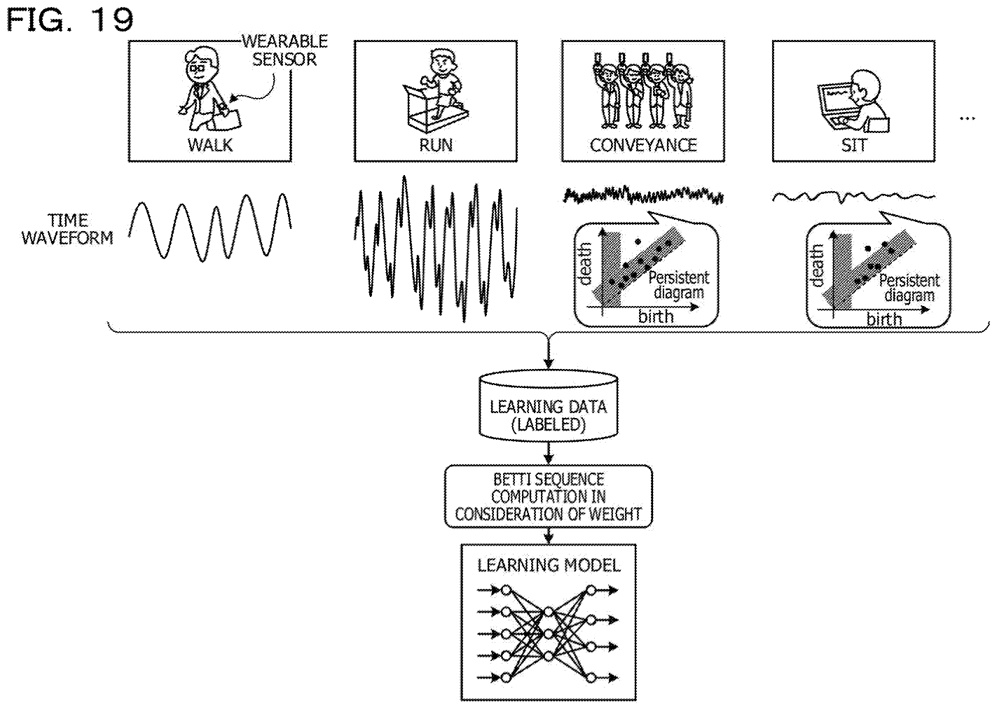

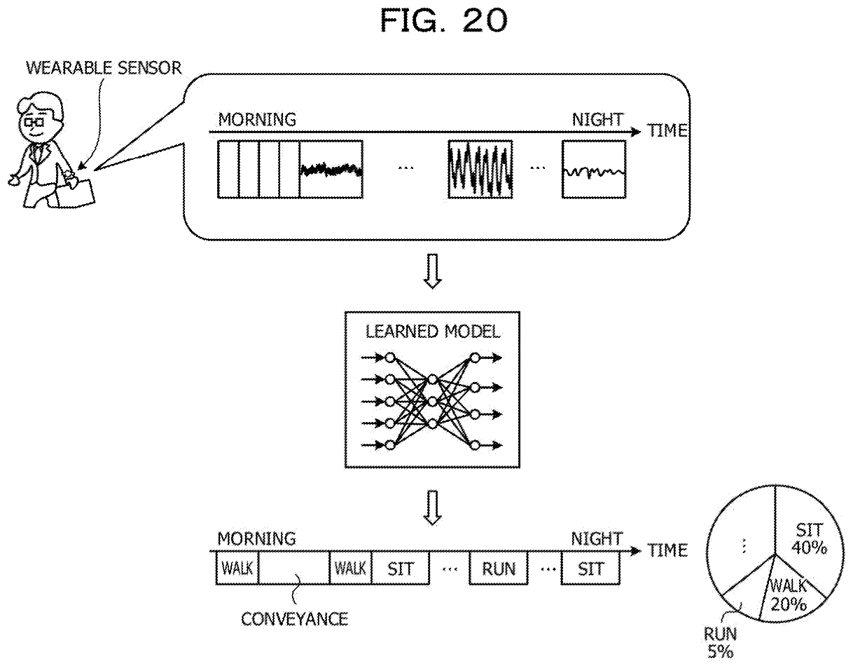

Next, an example of applying the method according to the embodiment 1 to classification of person's motion is described. FIG. 19 is an illustration depicting an example of learning in the application to classification of person's motion. FIG. 20 is an illustration depicting an example of inference in the application to classification of person's motion.

Here, time waveforms as an example of time series data measured by a wearable sensor worn by a user when the user moves are collected and labels indicating person's motion are set for the respective time waveforms. For example, a time waveform corresponding to a label “walk”, a time waveform corresponding to a label “run”, a time waveform corresponding to a label “conveyance”, and a time waveform corresponding to a label “sit” are generated in pairs as learning data. As illustrated in FIG. 19, conveyance and the motion of sit are motions with small vibrations, and thus, corresponding time waveforms tends to be similar to each other. Concerning these cases, by employing general denoising, indistinguishable phenomena are likely to occur.

In this regard, by using the feature extraction apparatus 10 according to the embodiment 1, when a Betti sequence is generated from items of learning data, it is possible to generate a Betti sequence by setting weight with respect to the time of existence and the appearance time, and as a result, it is possible to perform learning while the items of learning data are accurately distinguished from each other and thus improve the accuracy of learning a learning model.

Afterwards, by inputting a time waveform obtained from a wearable sensor of a user to the learned model, it is possible to predict the user's motion. For example, a time waveform that is from morning to a time to sleep and that is obtained by a wearable sensor is divided by predetermined intervals and inputted to a learned model. As a result, the feature extraction apparatus 10 displays results obtained by predicting the user's motions of the day and a graph at a display. The user or an administrator is able to accordingly grasp proportions of respective motions to utilize the information for health examinations and eliminating physical inactivity. Furthermore, by inputting, whenever desired, a time waveform obtained by a wearable sensor to a learned model, it is possible to predict the present motion of a user, and accordingly, it is possible to manage working conditions of the user.

### Embodiment 2

Incidentally, while the embodiment 1 described the example in which bar code data is generated from a weighted persistence diagram, a Betti sequence is accordingly generated, and features of time series data are consequently extracted, but this is not construed in a limiting sense. For example, it is possible to perform scoring directly by using the total of the time of existence obtained from the weighted persistence diagram.

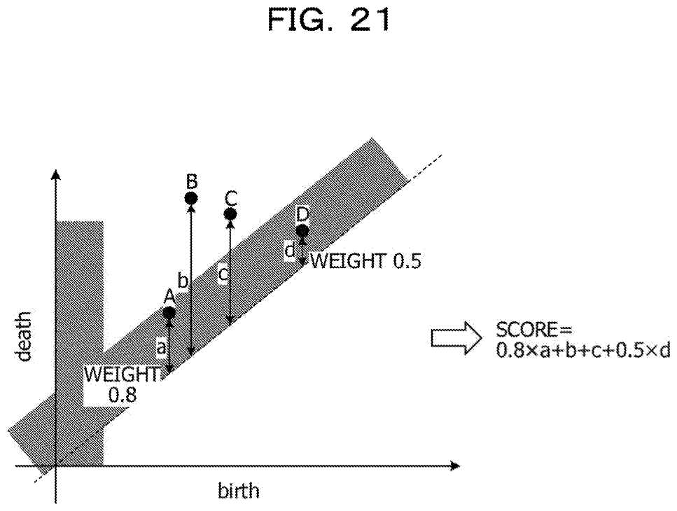

FIG. 21 is an illustration for explaining a method according to the embodiment 2. As illustrated in FIG. 21, the weight setting unit 23 of the feature extraction apparatus 10 set weight for the time of existence in a persistence diagram in accordance with information stored in the weight setting DB 15. Specifically, the weight setting unit 23 sets weight in accordance with the distance from the diagonal line in the persistence diagram. For weight setting, similarly to the embodiment 1, the method in FIGS. 15 and 16 may be employed. Although weight for the appearance time is omitted here, it is possible to set weight for the appearance time in a similar manner.

FIG. 21 illustrates an example in which the time of existence of data A is a, the time of existence of data B is b, the time of existence of data C is c, the time of existence of data D is d, a weight “0.8” is assigned to the data A, and a weight “0.5” is assigned to the data D, in which the data A and D belong to a range that extends from the diagonal line and that is targeted for removal. In this case, the feature extraction unit 24 extracts as a score (a feature) “0.8×a+b+c+0.5×d”.

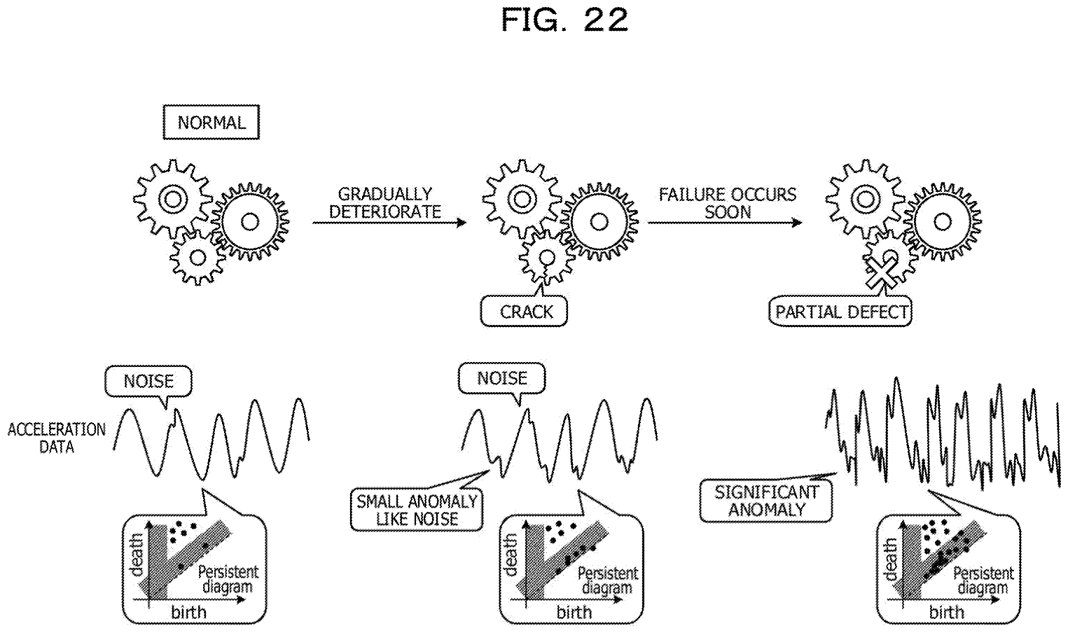

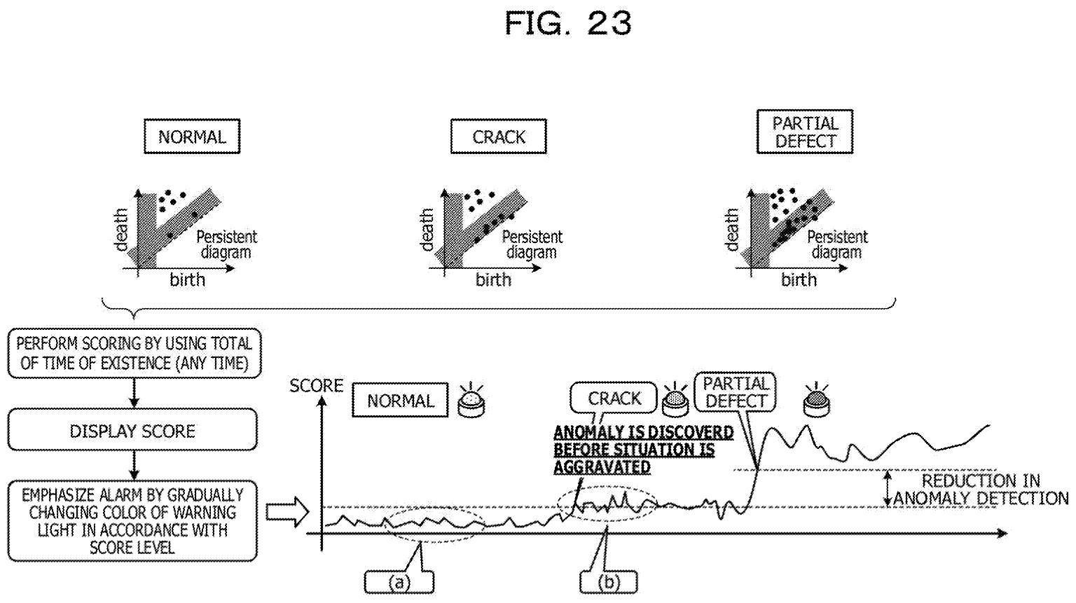

Next, an example of anomaly detection performed by employing a method in FIG. 21 is described. FIGS. 22 and 23 are illustrations for explaining an example in which a method according to the embodiment 2 is applied to anomaly detection. As illustrated in FIG. 22, components of industrial products such as sheaves and gears usually cause failure after the components are gradually changed from a normal state to a deteriorating state. Here, an example is described in which failure detection at an early stage is achieved by collecting acceleration data corresponding to each state and specifying changes in state in accordance with scores.

For example, noise caused by, for example, a measuring device is added to acceleration data measured in a normal state, but this does not considerably affect a waveform. In acceleration data measure a deteriorating state before the occurrence of failure such as cracks, a small waveform at an amplitude indicating small anomaly that seems like a noise, the number of items of data that appear in a range targeted for removal in the persistence diagram increases. In acceleration data measured at the time of failure such as cracks, a waveform that is apparently different from a waveform in a normal state and in which relatively short distance between peaks appears, and thus, the number of items of data that appears in a range targeted for removal in the persistence diagram is a considerably great number and data that corresponds to a high-frequency component and in which the time of existence is relatively long frequently appears.

As illustrated in FIG. 23, the feature extraction apparatus 10 performs scoring for a waveform measured whenever desired by using the total of the time of existence having subjected to weighting in the manner in FIG. 21, displays the score in time series, and emphasizes the alarm by gradually changing the color of a warning light in accordance with the level of the score.

As a result, the feature extraction apparatus 10 is able to precisely remove noise in a normal state, and thus, it is possible to accurately determine as normal a state (a) in which the score slightly increases due to noise in a normal state. The feature extraction apparatus 10 determines, at a time (b) at which data in denoising range increase, a normal state when any noise is deleted; but by performing scoring after weighting, the feature extraction apparatus 10 is able to determine a state in which anomaly is about to occur. In addition, since an administrator or the like is able to check changes in the score whenever desired, it is possible to detect, by setting a threshold or the like, an abnormal state before serious anomaly such as a partial defect appears.

### Embodiment 3

While the embodiments of the present disclosure have been described, the present disclosure may be implemented in various different forms other than the embodiments described above.

[Use of Feature]

While in the embodiments described above the example in which the feature extraction apparatus 10 employs learning or the like by using features is described, this is not construed in a limiting sense and the feature extraction apparatus 10 may extract and store features or provide features to another apparatus. Additionally, it is possible to perform anomaly detection in FIG. 23 by using features extracted by employing the method according to the embodiment 1.

[Weight Setting]

While in the embodiments described above the example of performing both weight setting based on the length of the time of existence and weight setting based on the appearance time is described, this is not construed in a limiting sense and only either one may be performed. Furthermore, the values of weight are an example and weight may be changed to any values when the values cause the importance of data belonging to the areas (a) or (b) Illustrated in FIG. 15 to decrease.

[Numerical Values or the Like]

The numerical values, set values of weight, the number of dimensions relating to quasi-attractors used in the embodiments are mere examples and may be changed in any manner. The input data and the learning method are also mere examples and may be changed in any manner. The features are also an example and other information may be used when the information indicates the feature of a Betti sequence. Various method such as neural networks may be employed for the learning model.

[System]

Processing procedures, control procedures, specific names, and Information containing various kinds of data and parameters indicated in the specification and the drawings may be changed in any manner unless otherwise specified.

The constituent elements of the devices illustrated in the drawings are functional conceptual ones and not necessarily configured physically as illustrated in the drawings. Specific forms of distribution and integration of the devices are not limited to those illustrated in the drawings. All or some of the devices may be functionally or physically distributed or integrated in any unit based on various loads, usage statuses, or the like.

All or some of the processing functions performed by the devices may be implemented by a central processing unit (CPU) and a program analyzed and run by the CPU or may be implemented by a hardware device using wired logic coupling.

[Hardware]

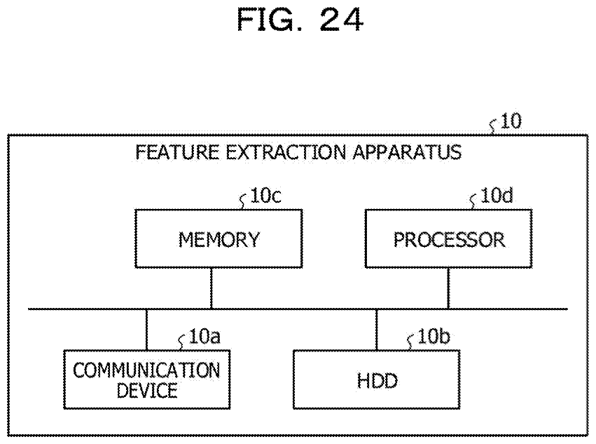

FIG. 24 illustrates an example of a hardware configuration. As illustrated in FIG. 24, the feature extraction apparatus 10 includes a communication device 10a, a hard disk drive (HDD) 10b, a memory 10c, and a processor 10d. The components illustrated in FIG. 24 are coupled to each other by, for example, a bus.

The communication device 10a is, for example, a network interface card and communicates with a server. The HDD 10b stores a program and DBs that implement functions illustrated in FIG. 3.

The processor 10d executes processes that implement the functions illustrated in, for example, FIG. 3 by reading from the HDD 10b or the like the program that implements processing operations identical to those of the processing units illustrated in FIG. 3 and loading the program into the memory 10c. For example, the processes implement the same functions as that of the processing units included in the feature extraction apparatus 10. Specifically, the processor 10d reads the program that implement the same functions as those of the PH processing unit 21, the diagram generation unit 22, the weight setting unit 23, the feature extraction unit 24, the feature processing unit 25, and the like from, for example, the HDD 10b. The processor 10d executes the processes that perform the same processing operations as those of the PH processing unit 21, the diagram generation unit 22, the weight setting unit 23, the feature extraction unit 24, the feature processing unit 25, and the like.

As described above, the feature extraction apparatus 10 functions as an information processing apparatus that implements a method for extracting features by reading and running the program. The feature extraction apparatus may also implement the same functions as those of the embodiments described above by reading the program from a recording medium with the use of a medium reading device and running the read program. The program described in other embodiments is not limited to a program that is run by the feature extraction apparatus 10. For example, the disclosure is applicable to the case in which another computer or a server runs the program or the case in which the other computer and the server cooperate to run the program.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A method for extracting features, the method being implemented by a computer, the method comprising:
generating attractors from time series data having a cyclic characteristic;
generating a persistence diagram by performing persistent homology conversion for the attractors;
changing a degree of influence with respect to individual items of data in the persistence diagram in accordance with a time of existence or an appearance time of a hole generated by performing the persistent homology conversion; and
extracting features of the time series data from the changed persistence diagram in which the degree of influence has been changed.

2. The method according to claim 1, wherein
the changing includes changing the degree of influence by setting a weight for each of the items of data in the persistence diagram, the weight being configured to gradually approach 0 when the time of existence is equal to or less than a particular value and to be a predetermined value when the time of existence is equal to or greater than the particular value.

3. The method according to claim 2, wherein
the extracting includes generating bar code data from the changed persistence diagram in which the degree of influence has been changed and generating a Betti sequence in accordance with the bar code data.

4. The method according to claim 1, wherein
the changing includes changing the degree of influence by setting a weight less than 1 for data that is in the persistence diagram and that corresponds to a hole of the appearance time equal to or less than a threshold.

5. The method according to claim 4, wherein
the extracting includes generating bar code data from the changed persistence diagram in which the degree of influence has been changed and generating a Betti sequence in accordance with the bar code data.

6. The method according to claim 1, wherein
the changing includes changing the degree of influence by setting a weight for each of the items of data in the persistence diagram, the weight being configured to gradually approach 0 when the time of existence is equal to or less than a particular value and to be a predetermined value when the time of existence is equal to or greater than the particular value.

7. The method according to claim 6, wherein
the extracting includes extracting as the features, from the changed persistence diagram in which the degree of influence has been changed, a total of the time of existence with respect to the items of data in the changed persistence diagram in which the degree of influence has been changed.

8. The method according to claim 1, wherein
the time series data is obtained, whenever desired, from a sensor that is set by a user,
the features of the time series data that are obtained whenever desired is displayed, and
a change in the features of the time series data is detected.

9. A non-transitory computer-readable storage medium storing a program that causes a computer to execute a process, the process comprising:
generating attractors from time series data having a cyclic characteristic;
generating a persistence diagram by performing persistent homology conversion for the attractors;
changing a degree of influence with respect to individual items of data in the persistence diagram in accordance with a time of existence or an appearance time of a hole generated by performing the persistent homology conversion; and
extracting features of the time series data from the changed persistence diagram in which the degree of influence has been changed.

10. An apparatus for extracting features, comprising:
a memory; and
a processor coupled to the memory and configured to:
generate attractors from time series data having a cyclic characteristic,
generate a persistence diagram by performing persistent homology conversion for the attractors,
change a degree of influence with respect to individual items of data in the persistence diagram in accordance with a time of existence or an appearance time of a hole generated by performing the persistent homology conversion, and
extract features of the time series data from the changed persistence diagram in which the degree of influence has been changed.

11. The apparatus according to claim 10, wherein the processor is configured to
change the degree of influence by setting a weight for each of the items of data in the persistence diagram, the weight being configured to gradually approach 0 when the time of existence is equal to or less than a particular value and to be a predetermined value when the time of existence is equal to or greater than the particular value.

12. The apparatus according to claim 11, wherein the processor is configured to
generate bar code data from the changed persistence diagram in which the degree of influence has been changed and generating a Betti sequence in accordance with the bar code data.

13. The apparatus according to claim 10, wherein the processor is configured to
change the degree of influence by setting a weight less than 1 for data that is in the persistence diagram and that corresponds to a hole of the appearance time equal to or less than a threshold.

14. The apparatus according to claim 13, wherein the processor is configured to
generate bar code data from the changed persistence diagram in which the degree of influence has been changed and generating a Betti sequence in accordance with the bar code data.

15. The apparatus according to claim 10, wherein the processor is configured to
change the degree of influence by setting a weight for each of the items of data in the persistence diagram, the weight being configured to gradually approach 0 when the time of existence is equal to or less than a particular value and to be a predetermined value when the time of existence is equal to or greater than the particular value.

16. The apparatus according to claim 15, wherein the processor is configured to
extract as the features, from the changed persistence diagram in which the degree of influence has been changed, a total of the time of existence with respect to the items of data in the changed persistence diagram in which the degree of influence has been changed.

17. The apparatus according to claim 10, wherein
the time series data is obtained, whenever desired, from a sensor that is set by a user,
the features of the time series data that are obtained whenever desired is displayed, and
a change in the features of the time series data is detected.
